(19) United States
(12) Patent Application Publication
(10) Pub. No.: US 2013/0139427 A1
(43) Pub. Date: Jun. 6, 2013

(54) BAIT-HOOKING APPARATUS

(71) Applicant: Clifford Land, Meridianville, AL (US)

(72) Inventor: Clifford Land, Meridianville, AL (US)

(21) Appl. No.: 13/690,264

(22) Filed: Nov. 30, 2012

Related U.S. Application Data
(60) Provisional application No. 61/565,593, filed on Dec. 1, 2011.

(51) Int. Cl. A01K 97/00

(52) U.S. Cl. CPC A01K 97/00
USPC 43/4

(57) ABSTRACT

Embodiments of the present disclosure generally pertain to bait-hooking apparatus and methods. A bait-hooking apparatus in accordance with an exemplary embodiment of the present disclosure comprises a handle, a stationary portion, and a pivoting portion. The stationary portion is rigidly secured to the handle and the pivoting portion is pivotally secured to the stationary portion. The stationary portion and the pivoting portion form a funnel having a tapered nozzle. The funnel has a plurality of holes, and the nozzle has a plurality of slots. The pivoting portion comprises a lever coupled to the funnel for pivoting the pivoting portion away from the stationary portion thereby opening the funnel and the nozzle.

### CROSS REFERENCE TO RELATED APPLICATION

This application claims priority to U.S. Provisional Application Ser. No. 61/565,593 entitled “Bait-Hooking Apparatus and Method” and filed on Dec. 1, 2011, which is incorporated herein by reference.

### RELATED ART

Fishermen often use live bait such as, for example, worms, minnows, crickets, or leaches, in order to attract and catch particular types of fish. The live bait is typically kept in a portable container which can be easily transported by the fishermen. In order to use such bait, a fisherman must secure the bait to a hook attached to the end of the fisherman's line. The fisherman typically retrieves the bait from the container with his hand. However, it is often quite difficult to retrieve the bait from the container due to the fact that the bait is alive and instinctively avoids the fisherman's grasp. Also, once the fisherman finally retrieves the bait, the bait often dislodges itself from the fisherman's grip by wiggling and/or jumping. Furthermore, securing the live bait to the hook is also typically problematic due to the difficulty of holding the bait in a proper position for securing the bait to the hook. Thus, the bait often escapes and is lost, and the fisherman must begin the bait-hooking process again. Accordingly, a bait-hooking apparatus and method for simplifying the bait-hooking process is desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a top perspective view of an exemplary bait-hooking apparatus in accordance with the present disclosure.

FIG. 2 is another top perspective view of the bait-hooking apparatus of FIG. 1.

FIG. 3 is a top perspective view of the bait-hooking apparatus of FIG. 1 in an open position.

FIG. 4 is a side plan view of the bait-hooking apparatus of FIG. 1.

FIG. 5 is a top plan view of the bait-hooking apparatus of FIG. 1.

FIG. 6 is a top plan view of the bait-hooking apparatus of FIG. 1 in an open position.

### DETAILED DESCRIPTION

Embodiments of the present disclosure generally pertain to bait-hooking apparatus and methods. A bait-hooking apparatus in accordance with an exemplary embodiment of the present disclosure comprises a handle, a stationary portion, and a pivoting portion. The stationary portion is rigidly secured to the handle and the pivoting portion is pivotally secured to the stationary portion. The stationary portion and the pivoting portion form a funnel having a tapered nozzle. The funnel has a plurality of holes, and the nozzle has a plurality of slots. The pivoting portion comprises a lever coupled to the funnel for pivoting the pivoting portion away from the stationary portion thereby opening the funnel and the nozzle.

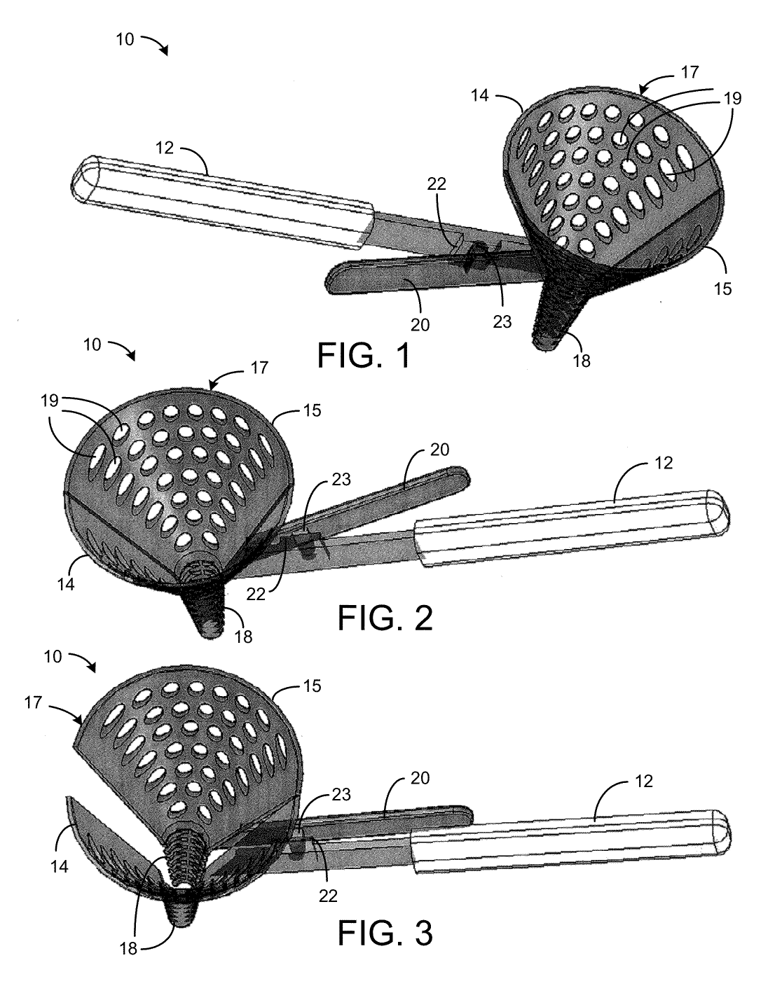

FIG. 1 depicts a top perspective view of an exemplary bait-hooking apparatus 10. The bait-hooking apparatus 10 comprises a handle 12, a stationary portion 14 and a pivoting portion 15. In one embodiment, the handle 12, the stationary portion 14, and the pivoting portion 15 comprise plastic, although other materials are possible in other embodiments. The stationary portion 14 rigidly extends from the handle 12. In one embodiment, the stationary portion 14 and the handle 12 comprise separate pieces secured to one another, such as, for example, by glue, but the stationary portion 14 and the handle 12 may comprise one piece of material in other embodiments. The stationary portion 14 and the pivoting portion 15 form a funnel 17 having a tapered nozzle 18, discussed in more detail hereafter. In one embodiment, the funnel 17 has a plurality of holes 19 for allowing water to escape the funnel 17, and the nozzle 18 has a plurality of slots (not shown in FIG. 1) for receiving a fishing hook (not shown). Furthermore, the pivoting portion 15 comprises a lever 20 extending from the funnel 17. When the lever 20 is actuated, the pivoting portion 15 pivots away from the stationary portion 14 thereby causing opposing portions of the funnel 17 to separate.

A fisherman (not shown) holds the apparatus 10 by the handle 12 and dips the funnel 17 into a portable container (not shown) in order to retrieve live bait, such as, for example, minnows, crickets, or leaches, from the container. For example, if the fisherman desires to retrieve a minnow from the container, the fisherman uses the funnel 17 to scoop the minnow from the container and capture the minnow. The minnow then instinctively swims into the nozzle 18 and is trapped, whereby the fisherman may hook the minnow with a fishing hook, discussed in more detail hereafter. The fisherman may then actuate the lever 20 in order to open the funnel 17 and remove the hooked bait, as will be discussed in more detail hereafter.

FIG. 2 depicts another top perspective view of the bait-hooking apparatus 10 of FIG. 1. As set forth above, the apparatus 10 comprises the stationary portion 14 rigidly secured to the handle 12 and the pivoting portion 15 pivotally secured to the stationary portion 14. The lever 20 extends from the funnel 17 at an angle such that the pivoting portion 15 pivots away from the stationary portion 14 and the funnel 17 opens when force is applied to a free end of the lever 20. 20. In one embodiment, the stationary portion 14 comprises a protruding base 22 positioned adjacent to the lever 20 and the lever 20 comprises a protrusion 23 extending towards the base 22 such that the base 22 receives the protrusion 23 and allows the pivoting portion 15 to pivot about the protrusion 23 and the base 22. Furthermore, in one embodiment, the apparatus 10 comprises a spring (not shown in FIG. 2) coupling the stationary portion 14 to the pivoting portion 15 at the base 22 and the protrusion 23 such that the spring opposes the force applied to the lever 20 and causes the pivoting portion 15 to return to a closed position when the bait has been removed from the nozzle 18. However, other means for maintaining the pivoting portion 15 in a closed position are possible in other embodiments.

FIG. 3 depicts a top perspective view of the bait-hooking apparatus 10 of FIG. 1 in an open position. In this regard, as shown by FIG. 3, the lever 20 is pivoted about the protruding base 22 towards the handle 12 such that the pivoting portion 15 of the funnel 17 pivots away from the stationary portion 14 and the funnel 17 is in an open position. Thus, the nozzle 18 is separated such that the bait (not shown) positioned within the nozzle 18 may be removed from the nozzle 18 via the hook (not shown) once the fisherman has hooked the bait upon the hook. Note that force must be constantly applied to the lever 20 in order to retain the pivoting portion 15 in an open position, and the pivoting portion 15 returns to a closed position when the force is removed from the lever 20. Accordingly, the fisherman may operate the apparatus 10 in one hand while hooking the bait with the other hand, and may simply apply force to the lever 20 in order to open the nozzle 18 and free the bait from the nozzle 18. Therefore, the bait-hooking process is simplified.

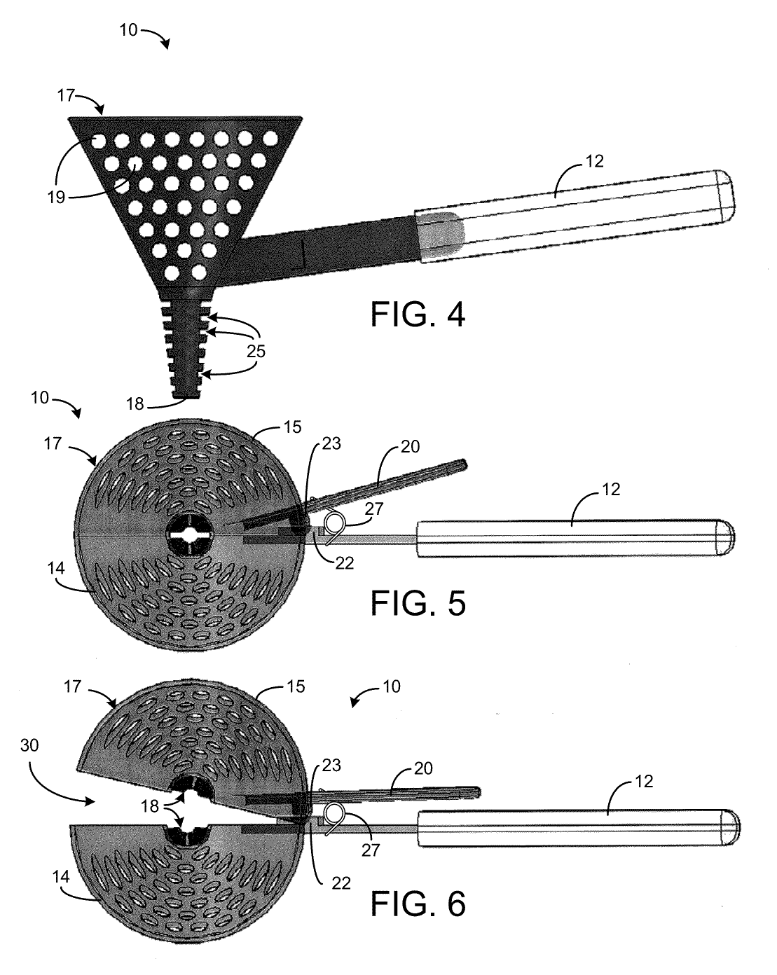

FIG. 4 depicts a side plan view of the apparatus of FIG. 4. As shown by FIG. 4, the funnel 17 comprises a plurality of holes 19 and the nozzle 18 comprises a plurality of slots 25. When hooking live bait is desired, the fisherman holds the apparatus 10 by the handle 12 and extends the funnel 17 down into the container (not shown) in order to retrieve the bait, such as, for example, a minnow. The bait is captured in the funnel 17 and instinctively travels into the nozzle 18 thereby becoming trapped. Note that the nozzle 18 is tapered such that the nozzle 18 becomes smaller at its tip such that the bait may enter the nozzle 18 from the funnel 17 but may not escape from the tip of the nozzle 18. When the bait is trapped within the nozzle 18, the fisherman may insert a hook (not shown) into one of the slots 25 in order to secure the bait to the hook. Once the bait is secured to the hook, the fisherman may open the funnel 17 in order to free the bait from the nozzle 18. Accordingly, the bait is secured to the hook without requiring the fisherman to handle the bait with his hands.

FIG. 5 depicts a top plan view of the bait-hooking apparatus 10 of FIG. 1. As set forth above, the lever 20 extends from the pivoting portion 15 at an angle such that the pivoting portion 15 may pivot away from the stationary portion 14 when the lever 20 is pivoted towards the handle 12. The protrusion 23 is positioned within the protruding base 22 in order to provide a fulcrum about which the pivoting portion 15 may pivot. Note that, in one embodiment, the pivoting portion 15 comprises half of the funnel 17 and half of the nozzle 18 such that transitioning the pivoting portion 15 to an open position causes the funnel 17 and the nozzle 18 to completely separate in half. However, the pivoting portion 15 may comprise a larger or smaller portion of the funnel 17 and the nozzle 18 in other embodiments. Furthermore, in one embodiment, the apparatus 10 comprises a spring 27 coupled to the handle 12 and to the lever 20. The spring 27 applies a force to an outer surface of the lever 20 and an outer surface of the handle 12 such that the pivoting portion 15 remains in contact with the stationary portion 14 of the funnel 17 and the funnel 17 remains in a closed position. When a force exceeding the force of the spring 27 is applied to the lever 20, the pivoting portion 15 pivots away from the stationary portion 14 such that the funnel 17 is in an open position, as will be discussed in more detail hereafter.

When the fisherman traps bait within the nozzle 18, any water captured within the funnel 17 escapes via the holes 19 and any water captured within the nozzle 18 escapes via the slots 25. The bait may then be safely and easily hooked upon the hook while the pivoting portion 15 is in the closed position depicted by FIG. 5.

FIG. 6 depicts a top plan view of the bait-hooking apparatus 10 of FIG. 1 in an open position. The lever 20 is pivoted about the protrusion 23 and the base 22 towards the handle 12 such that the force of the spring 27 is overcome and the pivoting portion 15 of the funnel 17 pivots away from the stationary portion 14. Thus, a gap 30 is created between the pivoting portion 15 and the stationary portion 14 such that the tunnel 17 and the nozzle 18 are divided in half and separated by the gap 30. The funnel 17 and the nozzle 18 are dimensioned such that the gap 30 is large enough to allow hooked bait to be removed from the nozzle 18 when the apparatus is in the open position. As set forth above, in one embodiment, force must be constantly applied to the lever 20 in order to overcome the force of the spring 27 and retain the apparatus 10 in an open position. When the force is removed from the lever 20, the three of the spring 27 on the lever 20 and the handle 12 causes the apparatus to return to the closed position. Thus, the apparatus 10 may be repeatedly used to capture bait and to simplify the bait-hooking process.

1. A bait-hooking apparatus, comprising:
a handle;
a stationary portion rigidly secured to the handle;
a pivoting, portion pivotally secured to the handle, the pivoting portion having a lever extending from the pivoting portion; and
a spring coupled to the lever and the handle,
wherein the stationary portion and the pivoting portion form a funnel having a plurality of holes and a tapered nozzle having a plurality of slots.

2. The bait-hooking apparatus of claim 1, wherein the handle, the stationary portion and the pivoting portion comprise plastic.

3. The bait-hooking apparatus of claim 2, wherein the spring comprises metal.

4. The bait-hooking apparatus of claim 1, further comprising a base positioned on the handle and a protrusion positioned on the lever, wherein the base receives the protrusion and the pivoting portion pivots about the base.

5. The bait-hooking apparatus of claim 1, wherein the tapered nozzle is dimensioned to receive live bait.

6. A bait-hooking apparatus, comprising:
a handle;
a stationary portion rigidly secured to the handle;
a pivoting, portion pivotally secured to the handle; and
a lever extending from the pivoting portion,
wherein the pivoting portion and the stationary portion form a funnel comprising a tapered nozzle having a plurality of slots dimensioned to receive a fish hook.

7. The bait-hooking apparatus of claim 6, further comprising a spring coupled to the handle and to the lever.

8. The bait-hooking apparatus of claim 7, wherein the funnel further comprises a plurality of holes.

9. The bait-hooking apparatus of claim 8, wherein the handle, the stationary portion and the pivoting portion comprise plastic.

10. The bait-hooking apparatus of claim 9, wherein the spring comprises metal.

11. The bait-hooking apparatus of claim 6, further comprising a base positioned on the handle and a protrusion positioned on the lever, wherein the base receives the protrusion and the pivoting portion pivots about the base.
